(19) United States
(12) Patent Application Publication
(10) Pub. No.: US 2021/0259268 A1
(43) Pub. Date: Aug. 26, 2021

(54) LOW SATURATES CANOLA WITH DESIRABLE FRIED POTATO FRY HOLD TIME

(71) Applicant: Cargill, Incorporated, Wayzata, MN (US)

(72) Inventors: Diliara IASSONOVA, Maple Grove, MN (US); Xiaolan LUO, Plymouth, MN (US)

(73) Assignee: Cargill, Incorporated, Wayzata, MN (US)

(21) Appl. No.: 17/255,061

(22) PCT Filed: Jun. 24, 2019
(86) PCT No.: PCT/US2019/038663

§ 371 Date: Dec. 22, 2020

Related U.S. Application Data
(60) Provisional application No. 62/688,595, filed on Jun. 22, 2018.

(51) Int. Cl. A23D 9/00; A23L 19/18; A23L 5/10

(52) U.S. Cl. CPC A23D 9/00; A23V 2002/00; A23L 5/11; A23L 19/18

(57) ABSTRACT

Described herein is a canola oil for frying potato fries comprising a total saturates content of from 3.5% to 5%, a linoleic acid content of greater than 18%, and a linolenic acid content of less than 3.0, wherein the canola oil improves the flavor of a fried potato fry over an extended hold time. Also described herein is a fried potato fry made with a canola oil wherein the canola oil comprises a total saturates content of from 3.5% to 5%, a linoleic acid content of greater than 18%, and a linolenic acid content of less than 3.0, wherein the fried potato fry has improved flavor over an extended hold time. Additionally described herein is a method of extending hold time of a fried potato fry, comprising frying a potato fry with the canola oil described herein.

### TECHNICAL FIELD

This invention generally relates to canola oil containing low levels of saturates that demonstrate desirable hold times and flavor profiles for potato fries fried with such oil.

### BACKGROUND

Diets high in saturated fatty acids, or saturates, have been linked to higher levels of cholesterol and an increased risk of cardiovascular disease. Current dietary guidelines recommend that saturated fat intake should not be more than 10% of total calories. Therefore, based on a 2,000 calorie a day diet, no more than about 20 grams of saturated fat should be consumed per day. Reduction in saturated fatty acids in oils can have an impact on oil performance, however. Hence, it is desirable to have both saturated fatty acid reduction and beneficial frying performance.

### SUMMARY

Described herein is a canola oil for frying potato fries comprising a total saturates content of from 3.5% to 5%, a linoleic acid content of greater than 18%, and a linolenic acid content of less than 3.0, wherein the canola oil improves the flavor of a fried potato fry over an extended hold time compared to commodity oils. Also described herein is a fried potato fry made with a canola oil wherein the canola oil comprises a total saturates content of from 3.5% to 5%, a linoleic acid content of greater than 18%, and a linolenic acid content of less than 3.0, wherein the fried potato fry improved flavor over an extended hold time compared to commodity oils. Additionally described herein is a method of extending hold time of a fried potato fry, comprising frying a potato fry with a canola oil comprising a total saturates content of from 3.5% to 5%, a linoleic acid content of greater than 18%, and a linolenic acid content.

### FIGURES

FIG. 1 shows the temperature profile of a fried potato fry over a hold time of 12 minutes.

FIG. 2 shows the overall appearance profile of a fried potato fry over a hold time of 12 minutes.

FIG. 3 shows the overall texture profile of a fried potato fry over a hold time of 12 minutes.

FIG. 4 shows the overall flavor profile of a fried potato fry over a hold time of 12 minutes.

FIG. 5 shows the overall quality profile of a fried potato fry over a hold time of 12 minutes.

FIG. 6 shows the potato flavor profile of fried potato fries over a hold time of 10 minutes using 10 day old frying oil.

FIG. 7 shows the potato flavor profile of fried potato fries over a hold time of 10 minutes using 15 day old frying oil.

FIG. 8 shows the potato flavor profile of fried potato fries over a hold time of 10 minutes using 20 day old frying oil.

FIG. 9 shows the bitterness of fried potato fries over a hold time of 10 minutes using 15 day old frying oil.

FIG. 10 shows the sourness of fried potato fries over a hold time of 10 minutes using 15 day old frying oil.

FIG. 11 shows the aged oil flavor of fried potato fries over a hold time of 10 minutes using 15 day old frying oil.

FIG. 12 shows the bitterness of fried potato fries over a hold time of 10 minutes using 20 day old frying oil.

FIG. 13 shows the sourness of fried potato fries over a hold time of 10 minutes using 20 day old frying oil.

FIG. 14 shows the aged oil flavor of fried potato fries over a hold time of 10 minutes using 20 day old frying oil.

Note that in figures referencing “CV Low Sat” that is the high oleic, low saturate canola oil described herein.

### DETAILED DESCRIPTION

The canola oil of the present invention has a combination of reduced saturates and improved hold times of potato fries fried with the canola oil.

“Total saturates”, as used herein, means the combination of the percentages of the following fatty acids which may be present in canola oils. Total Saturates refers to the total of myristic acid (C14:0), palmitic acid (C16:0), stearic acid (C18:0), arachidic acid (C20:0), behenic acid (C22:0), and lignoceric acid (C24:0).

“Oleic acid”, as used herein, means a C18:1 fatty acid. “Linoleic acid”, as used herein, means a C18:2 fatty acid. “Linolenic acid”, as used herein, means a C18:3 fatty acid.

“Refining or refined”, as used herein, means crude pressed or extracted canola oils that are treated by chemical or physical means to remove impurities or improve quality. Refining is well known the art and may include one or more steps to remove impurities. Any known processes to remove impurities or improve quality of vegetable oils is included within the definition of refining. See, e.g., Bailey's Industrial Oil and Fat Products, (6th Edition, 2005).

“Canola”, as used herein, means plants from the Brassica sp. including: Brassica juncea, Brassica rapa, and Brassica napus. Reference to a canola “plant” or “plants” includes the plant and its progeny, such as its F₁, F₂, F₃, F₄, and subsequent generation plants. In a specific embodiment canola is Brassica napus.

“Canola seed” or “seed”, as used herein, means the combined seeds harvested from one or more Brassica sp. plants.

Seeds harvested from plants described herein can be used to make a crude canola oil or a refined, bleached, and deodorized (RBD) canola oil with a low total saturates content. Harvested canola seed can be crushed by techniques known in the art. The seed can be tempered by spraying the seed with water to raise the moisture to, for example, about 8.5%. The tempered seed can be flaked using a smooth roller with, for example, a gap setting of 0.23 to 0.27 mm Heat may be applied to the flakes to deactivate enzymes, facilitate further cell rupturing, coalesce the oil droplets, or agglomerate protein particles in order to ease the extraction process. Typically, oil is removed from the heated canola flakes by a screw press to press out a major fraction of the oil from the flakes. The resulting press cake contains some residual oil. Alternatively, the tempered flakes can be extracted with hexane to yield an oil rich miscella. The miscella is subsequently desolventized to yield a crude oil. Both pressed and/or extraction processes are included in the definition of crushing.

Crude oil produced from the pressing operation typically is passed through a settling tank with a slotted wire drainage top to remove the solids expressed out with the oil in the screw pressing operation. The clarified oil can be passed through a plate and frame filter to remove the remaining fine solid particles. Canola press cake produced from the screw pressing operation can also be extracted with commercial hexane. The canola oil recovered after solvent evaporation from the extraction process is combined with the clarified oil from the screw pressing operation, resulting in a combined crude oil.

Free fatty acids and gums typically are removed from the crude oil by adding food grade phosphoric acid and heating the acidified oil in a batch refining tank. The acid serves to convert the non-hydratable phosphatides to a hydratable form, and to chelate minor metals that are present in the crude oil. The oil-acid mixture is subsequently treated with sodium hydroxide solution to neutralize the free fatty acids and the remaining phosphoric acid in the acid-oil mixture. The neutralized free fatty acids, metal salts, phosphatides, etc. (soapstock) are drained off from the neutralized oil. A water wash may be done to further reduce the soap content of the oil. The oil may be bleached and deodorized before use, if desired, by standard techniques known in the art. See, e.g., Bailey's Industrial Oil and Fat Products, (6th Edition, 2005).

Oils obtained from the Brassica plant described herein can have increased oxidative stability, which can be measured using, for example, an Oxidative Stability Index Instrument (e.g., from Omnion, Inc., Rockland, Mass.) according to AOCS Official Method Cd 12b-92 (revised 1993). Oxidative stability is often expressed in terms of “AOM” hours.

Linolenic Acid—As mentioned above, to maintain stability C18:3 levels should be kept as low as possible appreciating that it is increasingly difficult to produce plants with ultra low levels of linolenic acid. Embodiments of the present invention have linolenic acid level in canola seed of between 1.5% and 3%. Additional embodiments have levels from i) 1.5% to 2.5%; ii) 1.65% to 2.5%; or iii) 1.1% to 3.1%.

Linoleic—A specific level of C18:2 linoleic acid is desired in the canola seed an oil of the present invention. Embodiments of the present invention have linolenic acid level in the canola seed or oil of greater than 18% or 20%. Additional embodiments have levels from i) 21% to 28%; ii) 24% to 26%; iii) 21.1% to 28.8%; or iv) 18% to 30.6%.

Oleic—Embodiments of the present invention have oleic acid level in the canola seed or oil of greater than 60% or 65%. Additional embodiments have levels from i) 60% to 70%; ii) 63% to 68%; or iii) 59.9% to 73.6%.

Total Saturates—Embodiments of the present invention have a total saturates level of less than 5%. Commodity canola oils commonly used in industry and by consumers have a saturate levels of between 6-8%. See, e.g., Bailey's Industrial Oil and Fat Products, Section 2.2, “Canola Oil” on pages 61-121 of Volume 2 (6th Edition, 2005). Embodiments of the present invention have total saturates level in the canola seed or oil of between 3.5% and 5%. Additional embodiments have levels from i) 4% to 5%; ii) 4 to 4.5%; iii) 4.2% to 4.7%; and iv) 3.8% to 5.9%.

All possible combinations of the values for linoleic, linolenic, and total saturates mentioned above are within the scope of the present invention and are specifically contemplated by the inventor. For example, combinations include but are not envisioned to be limited to the following.

TABLE I

| Embodiment | % Linoleic | % Linolenic | % Total Saturates |
|---|---|---|---|
| A | >18 | 1.5-3 | 3.5-5 |
| B | >20 | 1.5-3 | 3.5-5 |
| C | >20 | 1.5-2.75 | 4-5 |
| E | 20-25 | 1.5-2.75 | 3.5-5 |
| F | 21-28 | 1.5-2.75 | 4-5 |
| G | 21-28 | 1.5-2.75 | 4.2-4.7 |
| H | 18-30.6 | 1.1-2.9 | 4.1-5.3 |

Embodiments in Table I can further comprise specific oleic acid content. Examples of embodiments with specific oleic content include but are not limited to the following: (>60%, >65%, 65% to 70%, 64% to 68%; and 59.9% to 73.6%.)

Three examples of such plants were deposited with the American Type Culture Collection.

| Example | Internal Designation | ATCC Designation |
|---|---|---|
| 1 | 15RH0611 | PTA-12314 |
| 2 | 15RH0612 | PTA-12315 |
| 3 | 15RH0613 | PTA-12316 |

Over time, oils tend to degrade over a period of time due to oxidation and other effects which impacts their frying performance over time. Surprisingly the low saturates oil described herein demonstrate beneficial frying properties on potato fry products for up to a twelve-minute hold time. “Hold time” is defined as the time post-frying, for example a two-minute hold time means the fried potato fry has been out of the fryer medium for two minutes. The fried potato fry demonstrates desirable temperature, appearance, texture, and quality profiles over a twelve-minute hold time. Such hold-time performance is desirable for quick service restaurant deliveries as the fried potato fry remains desirable to eat several minutes after being removed from the frying medium.

Embodiments of the present invention also include methods of frying potato fries, comprising heating the low saturates canola oil described herein to a temperature ranging from 330-340 F and immersing the potato fry in the heated oil for a frying time of about 3 minutes to 3 minutes and 30 seconds. This method produces a fried potato fry with desirable temperature, appearance, texture, and overall quality over a twelve-minute hold time.

Embodiments of the present invention also include a method of improving the hold time of fried potato fries, comprising heating the low saturates canola oil described herein to a temperature ranging from 330-340 F and immersing the potato fry in the heated oil for a frying time of about 3 minutes to 3 minutes and 30 seconds.

In preferred aspects, the potato fry can be par-fried prior to frying with the high oleic, low saturates canola oil described herein.

After the fried potato fry is removed from the fryer, the fried potato fry is typically transferred to a salting station under a heating lamp and then packed in a serving box. Hold time reference the temperature and period of elapsed time of the fried potato fry after it has been placed in serving box and no longer subject to further cooking or maintenance conditions.

In some aspects, the hold time of the fried potato fry is up to 10 minutes. In some aspects, the fried potato fry has a temperature of at least 70 C after a 10 minute hold time.

In some aspects, the hold time of the fried potato fry is up to 12 minutes. In some aspects, the fried potato fry has a temperature of at least 65 C after a 12 minute hold time.

Potato fries fried using the high oleic, low saturate canola oil described herein demonstrate improved flavor profiles over a hold time of 10 minutes when compared against commodity frying oil. For example, improved potato flavor and less bitterness, sourness, and aged oil flavor when frying in oil that is 10 days old, 15 days old and 20 days old. Such flavor attributes are determine using professional sensory panels where the attributes are defined based on:

| Attribute | Definition | References |
|---|---|---|
| Bitterness | Taste common to caffeine and | 125 ppm Caffeine in |
| | quinine | water -Bitter, 2 |
| | Bitter - 2, 5 | 310 ppm Caffeine in |
| | | water - Bitter, 5 |
| Sourness | Taste common to citric acid. | 0.035% Citric Acid in |
| | Sour - 2, 5 | water - Sour, 2 |
| | | 0.07% Citric Acid in |
| | | water - Sour, 5 |
| Potato Flavor | Flavor reminiscent of baked | Baked Potato - 8.0 |
| | potato. | |
| Aged Oil Flavor | Flavor reminiscent of oil that | Aged Commodity |
| | has been used previously to | So7bean Oil - 11.0 |
| | fry. | |

It shall be understood that while the many aspects described herein involve frying potato fries, such oil and methods can also be applied to meat and seafood protein sources, for example chicken.

### EXAMPLES

### Example 1

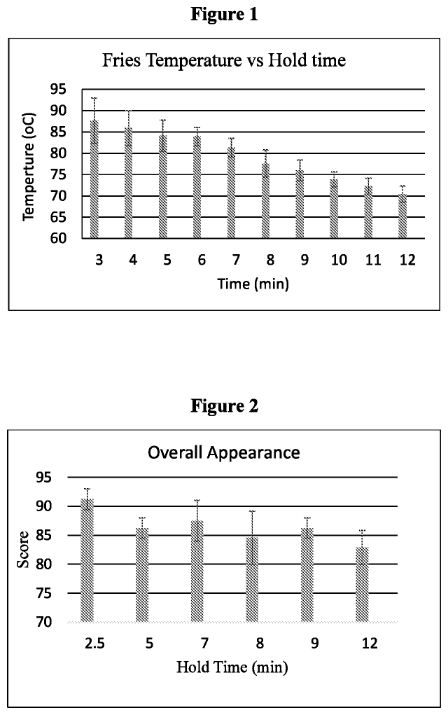

Par-fried potato fries are fried in the high oleic, low saturates canola oil described herein. The composition of the canola oil is 4.3% saturates, 73% oleic acid, 17% linoleic, and 1.7% linolenic. The par-fried potato fries were fried at a temperature of 330-340° F. for about 3 minutes to 3 minutes 30 seconds. The temperature of the fries, post frying, were recorded for 12 minutes in intervals of 1 minute. The results of this example are in FIG. 1. As illustrated in FIG. 1, at 3 minutes (post-frying) the fries are at a temperature around 87 C and at 12 minutes (post-frying) the fries are at a temperature around 71 C. These results are promising as they demonstrate the fries stay warm for a period of time after frying.

### Example 2

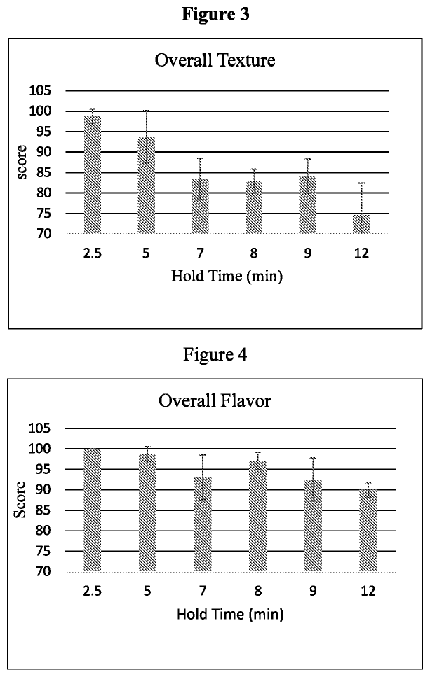

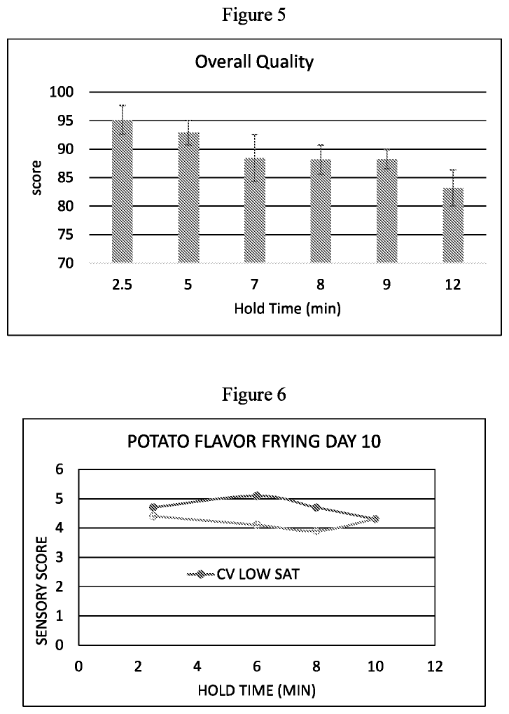

Par-fried potato fries are fried in the high oleic, low saturates canola oil described herein. The composition of the canola oil is 4.3% saturates, 73% oleic acid, 17% linoleic, and 1.7% linolenic. Six baskets of fries (1.5 lbs in each basket) were fried at a temperature of 335° F. for 3 minutes and 10 seconds. The six baskets were served for sensory at post-frying intervals at 2.5 minutes, 5 minutes, 7 minutes, 8 minutes, 9 minutes, and 12 minutes, respectively. FIGS. 2-5 represent the sensory analysis of overall appearance, texture, flavor and quality, respectively at each time interval. The results are promising as scores greater than 80 indicate desirable performance.

### Example 3

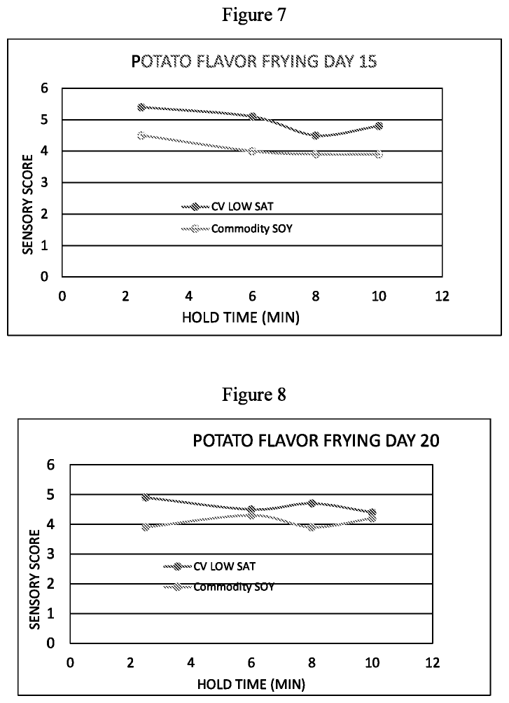

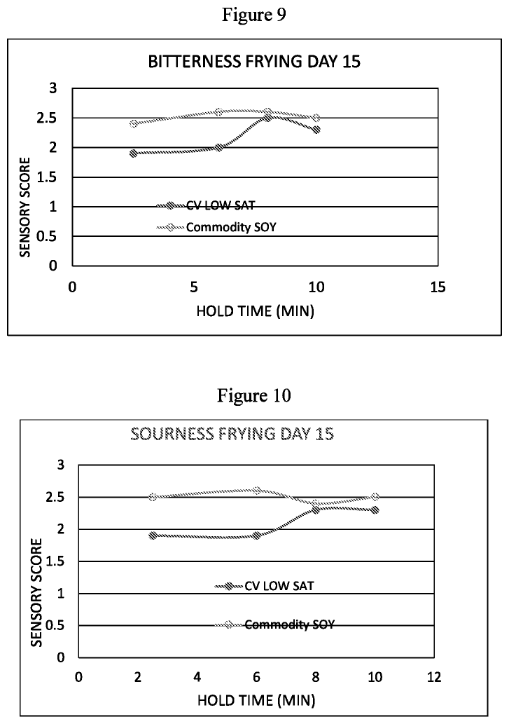

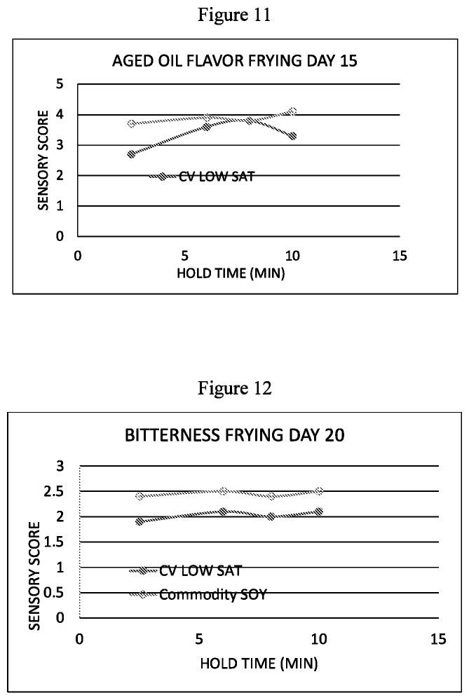

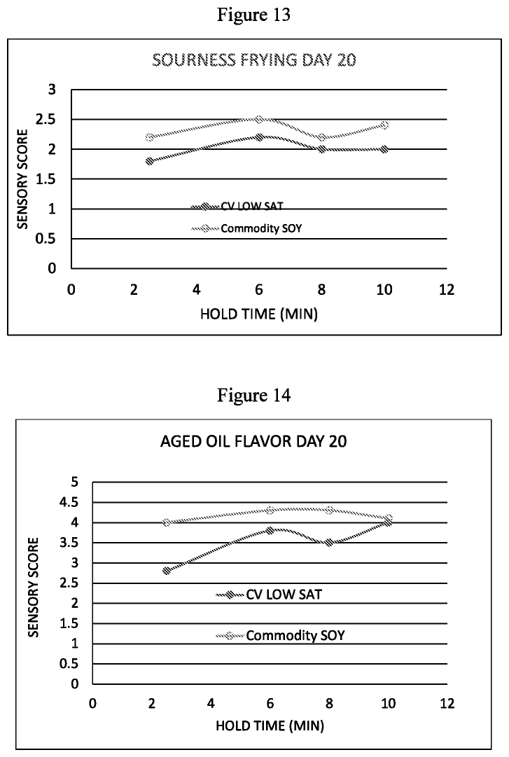

Throughout the hold time, potato fries fried in the high oleic, low saturates canola oil described herein demonstrate more preferable sensory characteristics than potato fries fried in commodity oils following similar frying procedures. As illustrated in FIGS. 6, 7, and 8 potato flavor of potato fries fried in the high oleic, low saturates canola oil described herein is preferred over commodity soybean oil over a 10 minute hold time of 10-day, 15-day, and 20-day old frying oil, respectively. As illustrated in FIGS. 9-14, potato fries are less bitter and sour and have less aged oil flavor, respectively, after a 10 minute hold time in 15-day and 20-day old frying oil when fried in the high oleic, low saturates canola oil described herein compared to commodity soybean oil.

1. A canola oil for frying potato fries comprising a total saturates content of from 3.5% to 5%, a linoleic acid content of greater than 18%, and a linolenic acid content of less than 3.0, wherein the canola oil improves the flavor of a fried potato fry over an extended hold time compared to commodity oils.

2. The canola oil of claim 1, wherein the hold time is up to 10 minutes.

3. The canola oil of claim 1, wherein the fried potato has a temperature of at least 70 C after a 10 minute hold time.

4. The canola oil of claim 1, wherein the hold time is up to 12 minutes.

5. The canola oil of claim 1, wherein the fried potato has a temperature of at least 65 C after a 12 minute hold time.

6. A fried potato fry made with a canola oil wherein the canola oil comprises a total saturates content of from 3.5% to 5%, a linoleic acid content of greater than 18%, and a linolenic acid content of less than 3.0, wherein the fried potato fry has an improved flavor over an extended hold time compared to commodity oils.

7. The fried potato fry of claim 6, wherein the hold time is up to 10 minutes.

8. The fried potato fry of claim 7 having a temperature of at least 70 C after a 10 minute hold time.

9. The fried potato fry of claim 6, wherein the hold time is up to 12 minutes.

10. The fried potato fry of claim 9 having a temperature of at least 65 C after a 12 minute hold time.

11. A method of extending hold time of a fried potato fry, comprising frying a potato fry with a canola oil comprising a total saturates content of from 3.5% to 5%, a linoleic acid content of greater than 18%, and a linolenic acid content of less than 3.0, wherein the fried potato fry has a hold time of up to 12 minutes and maintains desirable flavor characteristics.

12. The method of claim 11, comprising frying at a temperature ranging from 330-340 F.

13. The method of claim 12, comprising frying for approximately 3 minutes to 3 minutes and 30 seconds.

14. The method of claim 11, wherein the potato fry is a par-fried potato fry.

15. The method of claim 11, wherein the fried potato fry has a temperature of at least 65 C after a 12 minute hold time.

16. The method of claim 11, wherein the fried potato fry has a temperature of at least 70 C after a 10 minute hold time.
